(19) United States
(12) Patent Application Publication
(10) Pub. No.: US 2026/0071750 A1
(43) Pub. Date: Mar. 12, 2026

(54) Boiler Controller

(71) Applicant: MASSA Products Corporation, Hingham, MA (US)

(72) Inventors: Donald P. Massa, Scituate, MA (US); Dawn F. Stancavish, Marshfield, MA (US); Algis E. Karosas, Stowe, VT (US); Richard M. Rigby, Weymouth, MA (US); James G. Hall, Hingham, MA (US)

(21) Appl. No.: 19/044,535

(22) Filed: Feb. 3, 2025

Related U.S. Application Data
(63) Continuation of application No. PCT/US2022/039338, filed on Aug. 3, 2022.

(51) Int. Cl. F22B 37/78; F22B 35/18; H04Q 9/00

(52) U.S. Cl. CPC F22B 37/78; F22B 35/18; H04Q 9/00; H04Q 2209/86

(57) ABSTRACT

Disclosed, in one general aspect, is a boiler controller that includes an input for receiving a boiler water level signal, a screen having a data display that displays information. The data display includes an alphanumeric status indicator area responsive to the water level signal and operative to display status information about the water level signal in alphanumeric format, and a background indicator that extends around the alphanumeric status area and is operative to display a visual treatment that communicates different boiler safety levels. Disclosed in another general aspect is a boiler controller that includes an input for receiving a boiler water level signal and a compound level indicator that includes a vertically extending level-indicating device, a baseline reference level indicator positioned along the vertically extending level level-indicating device, and a visual treatment for the vertically extending level-indicating device that communicates different boiler safety levels. Water level outputs are also disclosed.

### CROSS-REFERENCE TO RELATED APPLICATION

This application is a continuation of PCT application no. PCT/US2022/039338, filed Aug. 3, 2022, which is herein incorporated by reference.

### FIELD OF THE INVENTION

This invention relates to boiler controllers, including electrical and user interface features for such controllers.

### BACKGROUND OF THE INVENTION

In traditional steam boiler systems, it is critical to maintain a sufficient level of water within the main boiler to, among other things, sustain proper boiler metal operating temperatures. The loss of a significant amount of water from the system can result in the catastrophic failure of the boiler. The super temperatures reached by the boilers with little or no water may cause damage and dangerous operating conditions.

In an attempt to monitor the level of the water in the boiler, it is common to use a float or other similar device that rises and falls with the actual level of the surface of the water inside the boiler. In such applications, the lowering of the float below a predefined level will cause a safety condition known as a low-water cutoff or LWCO. In response to such a condition, the system is shut-down prior to even more dangerous conditions being created due to exceedingly low water levels within the boiler.

Because of the importance of knowing what will happen as a result of variations in the boiler water level, testing of the safety procedures of the system occurs frequently, often including testing of redundant back-up systems. Indeed, testing of such parameters as low-water cutoff levels, auxiliary low-water cutoff levels and blowdown times is routinely conducted in most boiler systems.

Controllers have been proposed to improve the operation of boilers in a variety of ways. U.S. Pat. No. 7,409,301, which is herein incorporated by reference in its entirety, presents a software-based water level monitoring and control system used with conventional steam boilers that sets-up, monitors and records system functions, safety features, diagnostic testing histories and other functions. These features can help users to understand and operate boilers safely.

### SUMMARY OF THE INVENTION

In one general aspect, the invention features a boiler controller that includes an input for receiving a boiler water level signal, a screen having a data display that displays information. The data display includes an alphanumeric status indicator area responsive to the water level signal and operative to display status information about the water level signal in alphanumeric format, and a background indicator that extends around the alphanumeric status area and is operative to display a visual treatment that communicates different boiler safety levels.

In preferred embodiments the background indicator can communicate the different boiler safety levels through a color-based visual treatment. The background indicator can be presented in a data display and spans over at least about 50% of the unused area of the data display. The background indicator can be presented in a data display and span over at least about 60% of the unused area of the data display. The boiler controller can further include a water level output and the boiler controller can be further operative to provide a boiler water level output signal on the water level output. The boiler controller can further include a USB output with the boiler controller being further operative to provide a boiler water level output on the USB output. The boiler controller can further include a Modbus output with the boiler controller being further operative to provide a boiler water level output on the Modbus protocol output. The boiler controller can further include a 4-20 mA output with the boiler controller being further operative to provide a boiler water level output signal on the 4-20 mA output.

In another general aspect, the invention features a boiler controller that includes an input for receiving a boiler water level signal and a compound level indicator that includes a vertically extending level-indicating device, a baseline reference level indicator positioned along the vertically extending level level-indicating device, and a visual treatment for the vertically extending level-indicating device that communicates different boiler safety levels.

In preferred embodiments the compound level indicator can communicate the different boiler safety levels through a color-based visual treatment. The baseline reference level indicator can mark a level corresponding to a low water cutoff (LWCO) for the boiler. The boiler controller can further include a water level output and the boiler controller can be further operative to provide a boiler water level output signal on the water level output. The boiler controller can further include a USB output with the boiler controller being further operative to provide a boiler water level output on the USB output. The boiler controller can further include a Modbus output with the boiler controller being further operative to provide a boiler water level output on the Modbus protocol output. The boiler controller can further include a 4-20 mA output with the boiler controller being further operative to provide a boiler water level output signal on the 4-20 mA output.

Systems according to the invention can provide intuitive control metaphors to quickly and reliably convey the operational status of a boiler. And these can be organized progressively to alert and intuitively summarize the operating conditions of the boiler to the user while also allowing him or her to access detailed water level information and boiler status.

### BRIEF DESCRIPTION OF THE DRAWING

FIG. 1 is a schematic side sectional view of a boiler system that can be used with the boiler water level monitoring and control system of the present invention;

FIG. 2 is a partial schematic view of a water level monitoring and control system used with the boiler system of FIG. 1;

FIG. 3 is a schematic cross-section of a water level sensor housing with indicia showing for illustrative purposes different water levels for the boiler corresponding to normal conditions, conditions of concern, and dangerous conditions;

FIG. 4A is a diagram of a front side of a boiler controller that includes a data display in accordance with one aspect of the invention;

FIG. 4B is a diagram of a back side of the boiler controller of FIG. 4A that includes interface connectors;

FIG. 5A is a diagram of the boiler controller data display of FIG. 4A shown with the boiler in its normal operating condition;

FIG. 5B is a diagram of the boiler controller data display of FIG. 4A shown with the boiler in a concerning high water operating condition;

FIG. 5C is a diagram of the boiler controller data display of FIG. 4A shown with the boiler in a dangerously high water operating condition;

FIG. 5D is a diagram of the boiler controller data display of FIG. 4A shown with the boiler in dangerously low water operating condition;

FIG. 5E is a diagram of the boiler controller data display of FIG. 4A shown with the boiler in a sensor communication fault condition; and

FIG. 6 is a diagram of a blowdown maintenance screen for the boiler controller data display of FIG. 4A.

### DETAILED DESCRIPTION OF AN ILLUSTRATIVE EMBODIMENT

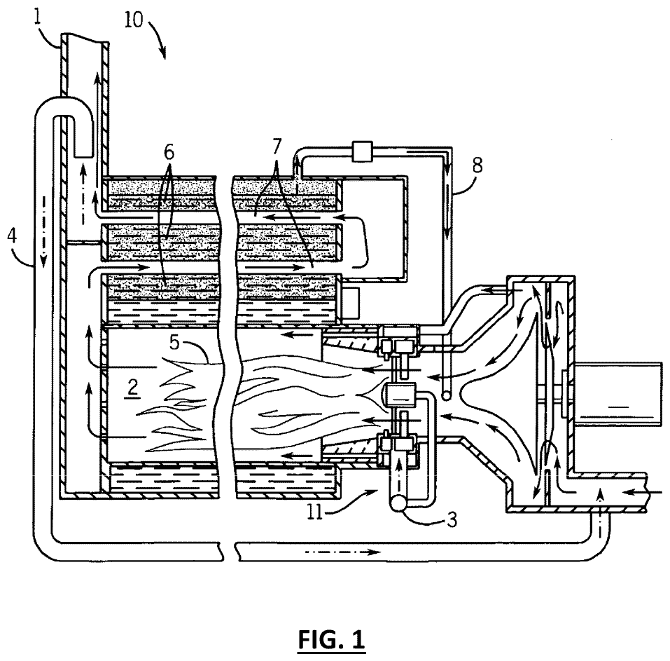

FIG. 1 is a side sectional view of one example of a steam boiler system that boiler water level monitoring and control systems of the present invention can be used with. Steam boiler 10 shown is a steam boiler and may be of either a watertube or firetube boiler. More specifically, FIG. 1 illustrates a boiler 10 and burner system 11 for use with the present invention. It is noted that the particular type or shape of boiler is not critical to the present invention, and that numerous conventional devices commonly employed with regular or packaged boilers are not shown (or at least not shown in intricate detail) so that the features of the present invention can be better and more clearly appreciated. The boiler 10 includes an exhaust stack 1 that extends from combustion chamber 2 to discharge combustion product from the boiler. Burner system 11 includes a burner 3 that can receive a fuel from a fuel source (not shown) to provide various fuels, such as, for example, propane and natural gas (typically in gaseous rather than liquid form), to power the burner. The burner is connected to combustion chamber 2. Recirculation tube 4 recovers combustion product (i.e., exhaust) such as flue gas (e.g., in the form of a moist heat) via a pick up line connected to exhaust stack 1. Some of the combustion product can then be returned to burner 3 via recirculation tube 4. Combustion chamber 2 provides an area for flame 5 to heat, for instance, a chamber 6 utilized for containing a liquid, such as water, using a plurality of fire tube pipes 7. Boiler 10 can also include a steam injection system having steam pipe 8 for reintroducing steam from the boiler to the burner. Monitoring the water level within the chamber 6 is critical to the operation of the boiler 10. Should the water level fall below, for example, one or more of the fire tube pipes 7, serious damage to or failure of the overall system could result.

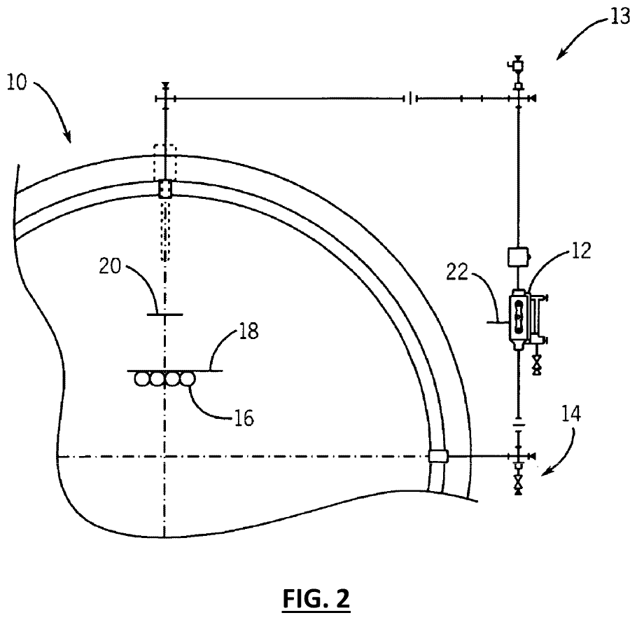

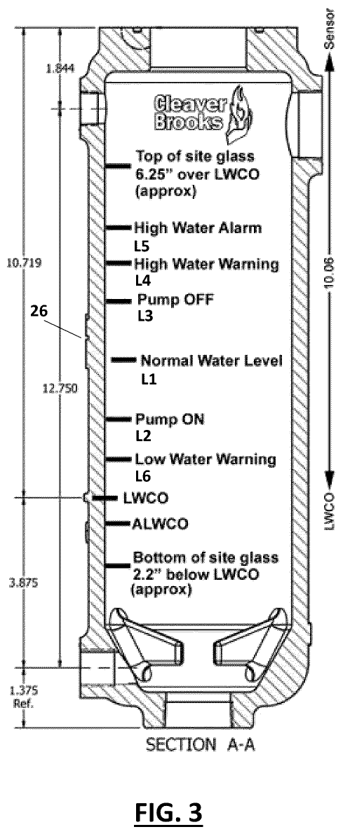

FIG. 2 is a partial schematic of a water level sensor 12, also called a level sensor assembly, used with steam boiler 10. Water level sensor 12 is connected to boiler 10 by a pipe assembly (generally 13) and including blowdown valve 14. Boiler 10 includes, in a known manner, tubes 16, which heat the water in the boiler. The top row of tubes defines line 18 under which water must always be present. To that end, and in further of the safety purpose for maintaining adequate water levels, a low water cutoff (LWCO) level 20 is defined at a location above the top line 18, defined tubes 16. The low water cutoff (LWCO) level 20 is that level at which, if the water level falls below, alarms will sound and safety precautions will be initiated. Water level sensor 12 is mounted such that a desired water level 22 corresponds to the LWCO level 20. This desired water level 22 may be made into a casting mark (26 of FIG. 3) and cast into the actual water level sensor 12 during production. Water level sensor 12 includes both a means for measuring a physical parameter of the steam boiler and a means for at least one of setting, maintaining and recording results of testing of the measuring means.

FIG. 3 is a schematic cross-section of the water level sensor 12 housing with indicia showing for illustrative purposes different water levels for the boiler corresponding to normal conditions, conditions of concern, and dangerous conditions. More specifically, the boiler has a specified normal water level L1. If it drops to a “pump on” level L2, more water will be pumped into the boiler. Once it then reaches a “pump off” level L3 the pump will be turned off. If it continues to rise despite the “pump off” condition, it will reach a high water warning level L4. This is considered a condition of concern and will be reported to the user. If the water still continues to rise, it will reach the high water alarm level L5, this will be reported to the user as a dangerous condition. If the water drops below the low water warning level L6 despite the “pump on” condition, this is considered a condition of concern and will be reported to the user. And if the water level drops below the LWCO, this will be reported to the user as a dangerous condition and the boiler will be automatically shut down. The level sensor can any suitable type of sensor operable to measure the level of water in the boiler, and provide input to the controller. In some examples, the sensor may include a magnetic float or other type of sensor that measures the level of water in the boiler, including but not limited to an ultrasonic sensor or sensing assembly. In one example, the sensor may be an ultrasonic sensor as described in PCT Patent Application No. PCT/US2022/039342, filed on Aug. 3, 2022 under docket number M00011-004001 and entitled “POSITION DETECTION IN HOSTILE ENVIRONMENTS USING REFLECTED RADIATED ENERGY”, which is herein incorporated by reference in its entirety.

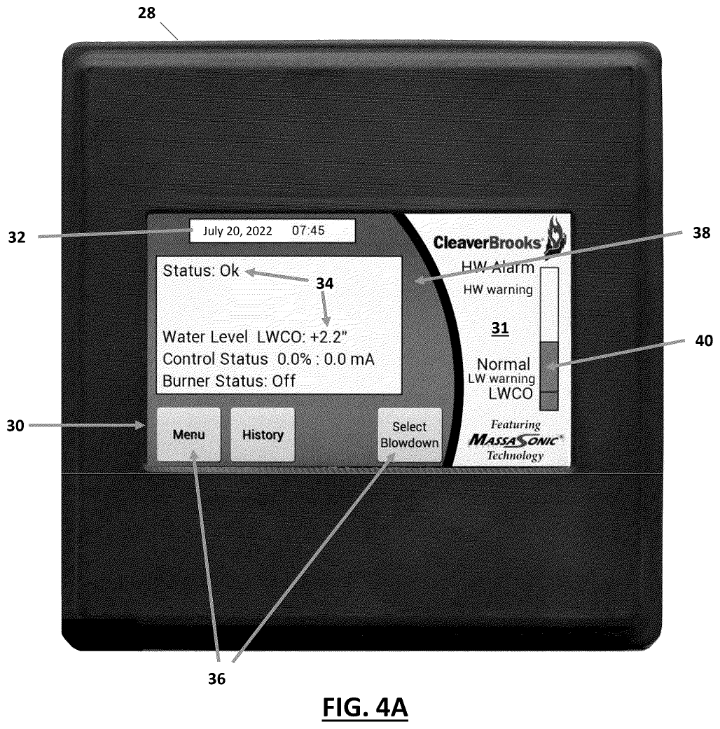

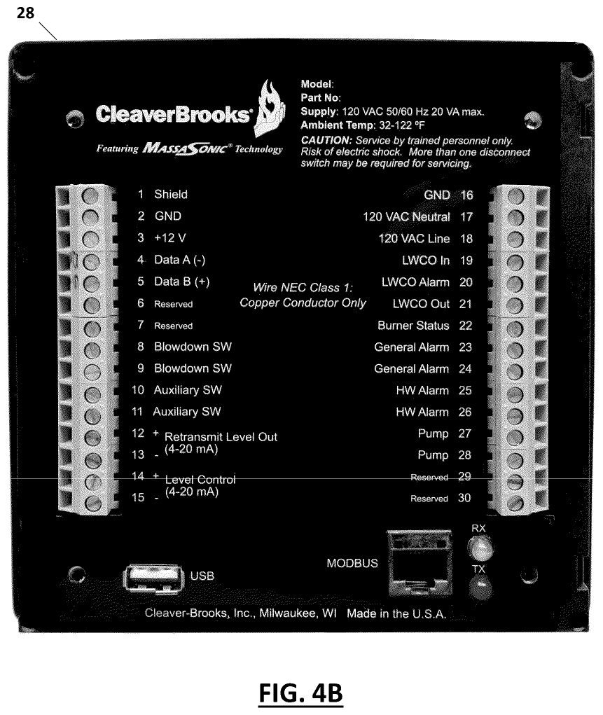

FIG. 4A is a front view of a boiler controller 28 that includes a data display 30. Controller 28 provides the electronics and memory for processing and storing of the information recorded as well as current conditions of the boiler water levels and related information. Controller 28 also provides the input/output capabilities necessary to input and retrieve data regarding the water level system as well as any diagnostic information which may be available. Controller 28 may also receive additional programming and commands in order to change operational parameters or to facilitate diagnostic retrieval.

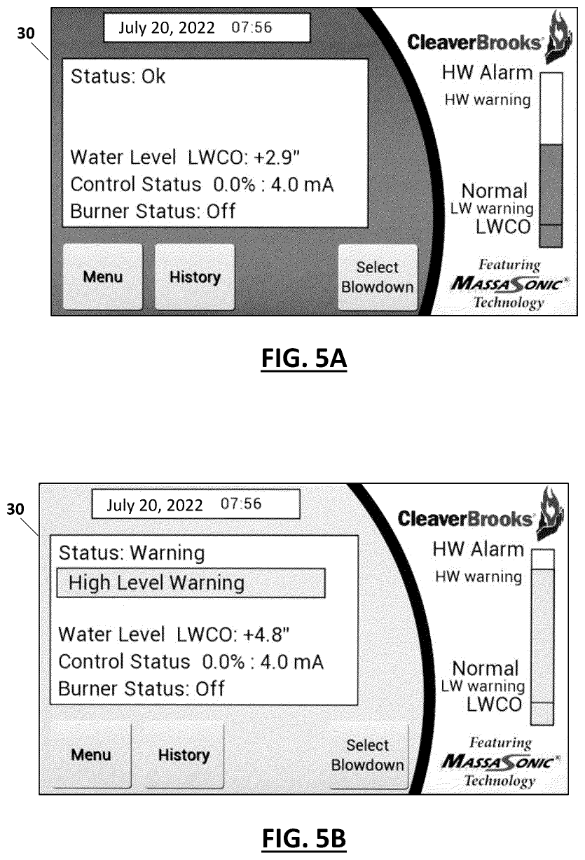

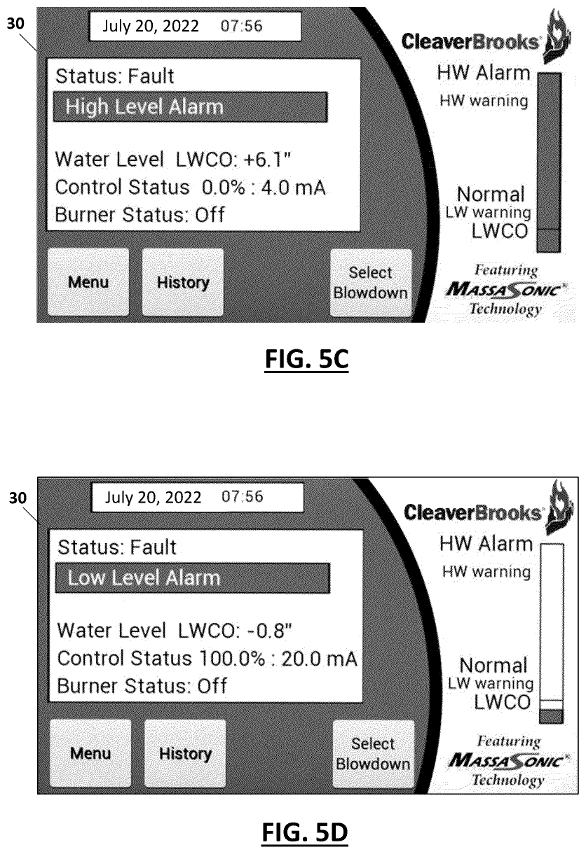

The controller 28 includes a screen 30 that displays information about the boiler. In the illustrated example, the screen is a touch screen that displays information about the boiler and receives touch-based commands from the user. The screen 30 includes a data display 31 that includes a date and time area 32, an alphanumeric status display area 34, and controls 36 inside a background indicator 38. The alphanumeric status display area presents status information such as boiler status, water level, control status, and burner status. The controls allow the user to access functions such as menus, history, and blowdown selection. The background indicator 38 aids in determining a current risk level associated with a current water level and will be discussed in more detail in connection with FIGS. 5A-5D.

The controller further includes a compound level indicator 40. This indicator employs a variable fill metaphor that communicates a fill level for the boiler by presenting a rising and falling colored fill indicator rectangle inside of fixed level sensor rectangle. It also includes a line corresponding to the LWCO. The rectangle is further colored according to a safety scheme, with red=dangerous, yellow=caution, and green=normal. As shown in FIG. 4A, the rectangle is colored green, indicating normal operation. As the water level changes, the height of the colored fill indicator rectangle would change as well, indicating a rise or fall in the water level. Correspondingly, the color of the colored fill indicator rectangle changes to yellow when the water level is outside the normal range but not yet dangerous, and to red when the water level is dangerous. The combined features of this compound level indicator provide an easy-to-grasp visual explanation of the boiler's current operation status.

Referring to FIG. 5A, in normal operation, the background indicator 38 shows its normal color, such as green. The compound level indicator 40 shows that the water level is above the low water warning level and below the high water warning level. The colored fill indicator rectangle of the compound level indicator 40 shows its normal color, which is in this embodiment is also green.

Referring to FIG. 5B, in high water warning condition, the background indicator 38 shows its caution color, such as yellow. The compound level indicator 40 shows that the water level is above the high water warning level. The colored fill indicator rectangle of the compound level indicator 40 shows its caution color, which is in this embodiment is also yellow.

In the low water warning condition (not shown), the background indicator 38 shows its caution color, such as yellow. The compound level indicator 40 shows that the water level is below the low water warning level but above the LWCO. The colored fill indicator rectangle of the compound level indicator 40 shows its caution color, which is in this embodiment is also yellow.

Referring to FIG. 5C, in high water alarm condition, the background indicator 38 shows its dangerous color, such as red. The compound level indicator 40 shows that the water level is above the high water alarm level. The colored fill indicator rectangle of the compound level indicator 40 shows its dangerous color, which is in this embodiment is also red.

Referring to FIG. 5D, in low water alarm condition, the background indicator 38 shows its dangerous color, such as red. The compound level indicator 40 shows that the water level is below the LWCO. The colored fill indicator rectangle of the compound level indicator 40 shows its dangerous color, which is in this embodiment is also red.

Referring to FIG. 5E, when the boiler controller cannot communicate with the water level sensor, a sensor communication fault condition is triggered. In this condition, the background indicator 38 shows its dangerous color with a distinguishing area treatment, such red with white hatches. The compound level indicator 40 is configured in this embodiment to show that the water level is empty in the sensor communication fault condition, even if the water level may not in fact be low.

The background indicator 38 should cover a substantial area of the screen outside of UI elements such as the date and time area 32, an alphanumeric status display area 34, and controls 36, preferably spanning most of the unused area around those elements. In this embodiment the background indicator spans over 50% of the LCD screen, but it can span over 60% or even substantially over the whole screen. In this embodiment, the background indicator and the compound level indicator use the same color scheme.

The controller's display components cooperate to provide progressively more information. The background indicator 38 is easily visible at a distance and can alert a user to a condition of concern or confirm the boiler's normal operation. The compound level indicator 40 can then quickly provide the user with more information about the condition in an intuitive format. And the alphanumeric status display area 34 can then be consulted for details on the status of the boiler. This progressive combination of features therefore advantageously alerts and intuitively summarizes increasingly more information about the operating conditions of the boiler to the user while also allowing him or her to access detailed water level information and boiler status.

Referring to FIG. 4B, the sensor provides a water level signal on a pair of water level signal inputs (connector numbers 4 and 5). This water level signal from the water level sensor can be relayed to further equipment for oversight, alarm, or other purposes. In this embodiment, the water level signal can be translated to data format and provided through a USB output (marked “USB”), a Modbus protocol output (marked “Modbus”), and in the form of a 4-20 mA analog signal (connector numbers 12 and 13).

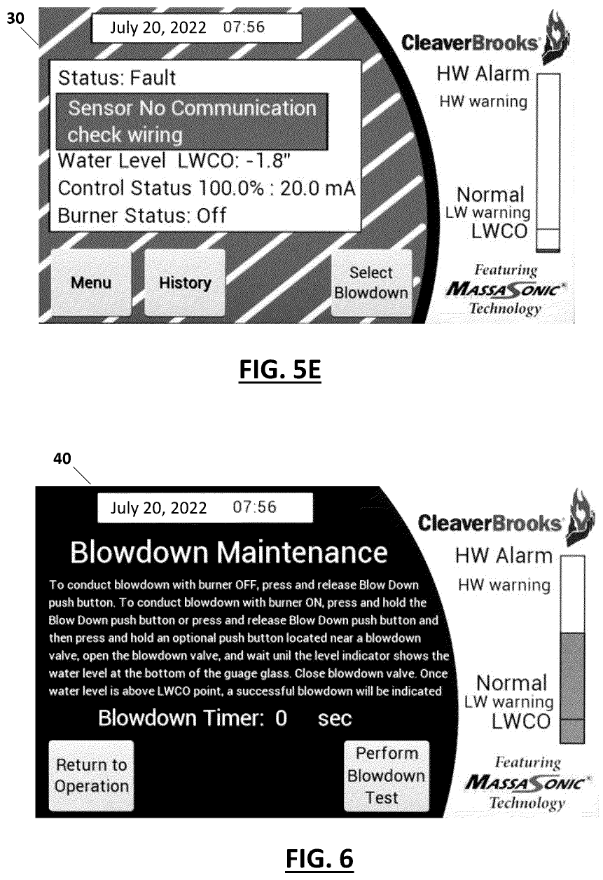

Referring to FIG. 6, a blowdown maintenance screen can be reached through one of the controls 36 in the home screen. This control allows the user to initiate a blowdown sequence with the burner on or off.

The system described above has been implemented in connection with stored special-purpose software programs running on a general-purpose controller platform, but it could also be implemented in whole or in part using virtualized platforms and/or special-purpose hardware.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A boiler controller, comprising:
an input for receiving a boiler water level signal,
a screen having a data display that displays information;
wherein the data display includes:
an alphanumeric status indicator area responsive to the water level signal and operative to display status information about the water level signal in alphanumeric format, and
a background indicator that extends around the alphanumeric status area and is operative to display a visual treatment that communicates different boiler safety levels.

2. The apparatus of claim 1 wherein the background indicator communicates the different boiler safety levels through a color-based visual treatment.

3. The apparatus of claim 1 wherein the background indicator is presented in a data display and spans over at least about 50% of the unused area of the data display.

4. The apparatus of claim 1 wherein the background indicator is presented in a data display and spans over at least about 60% of the unused area of the data display.

5. The apparatus of claim 1 wherein the boiler controller further includes a water level output and the boiler controller is further operative to provide a boiler water level output signal on the water level output.

6. The apparatus of claim 1 wherein the boiler controller further includes a USB output and the boiler controller is further operative to provide a boiler water level output on the USB output.

7. The apparatus of claim 1 wherein the boiler controller further includes a Modbus output and the boiler controller is further operative to provide a boiler water level output on the Modbus protocol output.

8. The apparatus of claim 1 wherein the boiler controller further includes a 4-20 mA output and the boiler controller is further operative to provide a boiler water level output signal on the 4-20 mA output.

9. A boiler controller, comprising:
an input for receiving a boiler water level signal,
a compound level indicator that includes:
a vertically extending level-indicating device,
a baseline reference level indicator positioned along the vertically extending level level-indicating device, and
a visual treatment for the vertically extending level-indicating device that communicates different boiler safety levels.

10. The apparatus of claim 9 wherein the compound level indicator communicates the different boiler safety levels through a color-based visual treatment.

11. The apparatus of claim 9 wherein the baseline reference level indicator marks a level corresponding to a low water cutoff (LWCO) for the boiler.

12. The apparatus of claim 9 wherein the boiler controller further includes a water level output and the boiler controller is further operative to provide a boiler water level output signal on the water level output.

13. The apparatus of claim 9 wherein the boiler controller further includes a USB output and the boiler controller is further operative to provide a boiler water level output on the USB output.

14. The apparatus of claim 9 wherein the boiler controller further includes a Modbus output and the boiler controller is further operative to provide a boiler water level output on the Modbus protocol output.

15. The apparatus of claim 9 wherein the boiler controller further includes a 4-20 mA output and the boiler controller is further operative to provide a boiler water level output signal on the 4-20 mA output.
